(19) United States
(12) Patent Application Publication
(10) Pub. No.: US 2022/0172039 A1
(43) Pub. Date: Jun. 2, 2022

(54) MACHINE LEARNING TECHNIQUES TO PREDICT DOCUMENT TYPE FOR INCOMPLETE QUERIES

(71) Applicant: Microsoft Technology Licensing, LLC, Redmond, WA (US)

(72) Inventors: Xiaowei LIU, Mountain View, CA (US); Weiwei GUO, Foster City, CA (US); Huiji GAO, Sunnyvale, CA (US); Bo LONG, Palo Alto, CA (US)

(21) Appl. No.: 17/107,524

(22) Filed: Nov. 30, 2020

(51) Int. Cl. G06N 3/08; G06N 3/04; G06F 16/242

(52) U.S. Cl. CPC G06N 3/08; G06F 16/2425; G06N 3/0445

(57) ABSTRACT

Techniques for using machine learning to predict document types for incomplete queries are provided. In one technique, one or more characters from input are identified. For each character, an embedding that corresponds to that character is retrieved. The embedding was machine-learned while training a neural network that outputs multiple classifications, each corresponding to a different document type. One or more embeddings, each corresponding to one of the characters, are input into the neural network. Based on the inputting, the neural network generates an output that comprises multiple values that includes (1) a first value that reflects a first probability that the input is associated with a first document type and (2) a second value that reflects a second probability that the input is associated with a second document type. Based on the first and second probabilities, a set of query completions is identified and presented on the computing device.

### TECHNICAL FIELD

The present disclosure relates to neural networks and, more particularly, using a neural network to predict a document type based on previous electronic searches across multiple document types.

### BACKGROUND

Modern content platforms host multiple types of documents. Examples of types of documents include user profiles, company profiles, academic institution profiles, group profiles, event profiles, job postings, and articles. Allowing users of a content platform to search for documents of varying types increases the utility of the content platform.

One approach for allowing a user to search documents of varying types requires a user to specify one or more document types in which the user is interested and in which the user wishes the search to be performed. Once the user has entered a fully formed query and submits input instructing the content platform to begin an electronic search, the content platform conducts the search with the term(s) of the query and limits the search to only those documents of the specified document type(s). However, requiring the user to specify the document type(s) decreases the utility of the content platform for at least two reasons: (1) the user may incorrectly specify the wrong document type(s) and (2) requiring the additional input violates a design principle that the minimal amount of information from the user should be requested.

Requiring a user to specify an entire query before performing a search also decreases the utility of the content platform. A significant amount of information may be known about a partially-formed (or “incomplete”) query without requiring the user to enter the remaining characters. Consequently, technologies have been developed to automatically complete an incomplete query, thus, enabling a user to view a set of auto-complete queries that the user did not enter and select one of the auto-complete queries. In this way, a user can obtain search results in a few inputs, such as a few keystrokes and a selection of an auto-complete query.

However, without knowing the type of documents that a user is seeking, none of the auto-complete queries may be relevant to the user. For example, if all auto-complete queries assume that the user is searching for one or more documents of a first type, when in reality the user is searching for one or more documents of a second type, then none of the auto-complete queries will be selected by the user, forcing the user to enter all the characters into a query forming interface.

Current approaches for predicting document type are inaccurate and, as a result, the utility of automatically completing an incomplete query is significantly reduced. One approach for predicting document type is to track what percentage of searches result in a user selecting a document of a first document type, what percentage of searches result in a user selecting a document of a second document type, and so forth for each document type. If the percentage corresponding to the first document type is equal to the percentage corresponding to the second document type, then the number of auto-complete queries that corresponding to the first document type is roughly equal to the number of auto-complete queries that corresponding to the second document type. However, this approach to predicting document type does not take into account the incomplete query itself. Instead, that approach assumes a fixed composition of auto-complete queries.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for generating auto-complete queries, in an embodiment;

FIG. 2 is a block diagram that depicts an example query auto-completion component, in an embodiment;

FIG. 3 comprises screenshots of example presentations of a user interface as a user inputs an incomplete query, in an embodiment;

FIG. 4 is a flow diagram that depicts an example process 400 for processing incomplete queries, in an embodiment;

FIG. 5 is a block diagram that depicts an example LSTM network for predicting document type based on an incomplete query, in an embodiment;

FIGS. 6-8 are block diagrams that depict simplified versions of an LSTM network in which a language feature is modeled therein, in an embodiment;

FIG. 9 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for using a neural network to predict document type in query autocompletion are provided. In one technique, a neural network is trained based on a log of incomplete queries and user selections of auto-completed queries, each corresponding to a different document type. An embedding that (a) has been machine-learned while training the neural network and (b) corresponds to each character that a user inputs through an interface of a computing device is retrieved and the retrieved embeddings are inputted into the neural network. The neural network, in turn, generates output that comprises multiple values that includes (1) a first value that reflects a first probability that the input reflects a first document type and (2) a second value that reflects a second probability that the input reflects a second document type. Based on the first and second probabilities, a set of auto-complete query is identified and presented on the computing device.

Embodiments improve computer-related technology by improving the accuracy of document type prediction in query auto-completion. A neural network assists in the improved accuracy. Consequently, less user input is required to present a relevant auto-completed query that a user may select. With less user input, the likelihood of incorrect or unintended user input decreases and the likelihood of poor or irrelevant results also decreases.

### System Overview

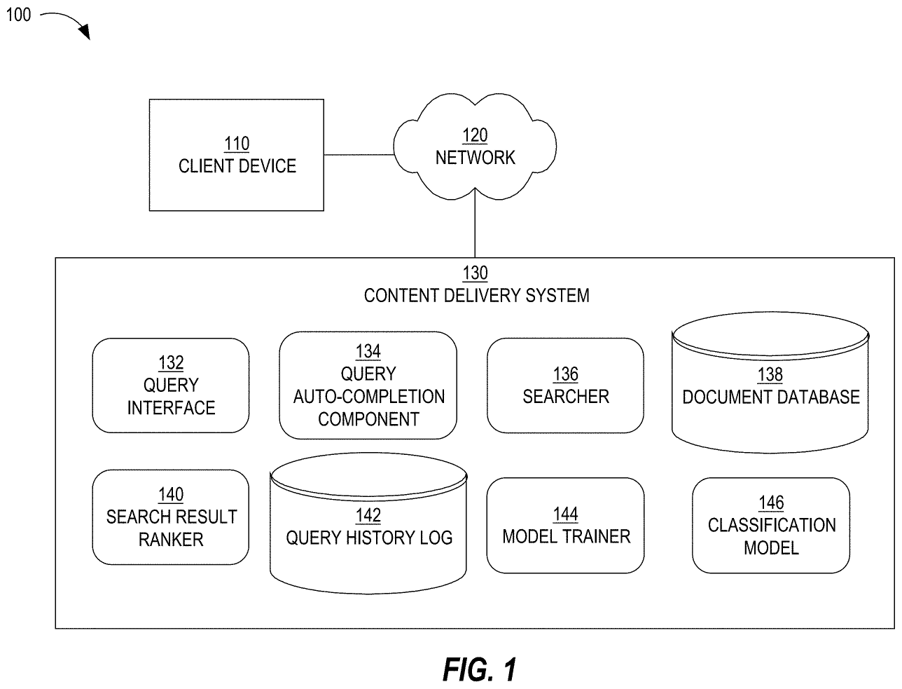

FIG. 1 is a block diagram that depicts an example system 100 for generating auto-complete queries, in an embodiment. System 100 includes a client device 110, a network 120, and a content delivery system 130. Although only a single client device is depicted, multiple client devices may be communicatively coupled to content delivery system 130 through network 120 and/or other networks (not depicted). Content delivery system 130 comprises one or more computing elements that perform the operations described herein as being performed by content delivery system 130. Network 120 is a computer network, examples of which include a local area network (LAN), a wide area network (WAN), and the Internet.

Content delivery system 130 includes a query interface 132, a query auto-completion component 134, a searcher 136, a document database 138, a search result ranker 140, a query history log 142, a model trainer 144, and a classification model 146.

Examples of client device 110 include a desktop computer, a laptop computer, a tablet computer, a wearable device, a video game console, and a smartphone. Client device 110 transmits input comprising one or more query terms over network 120 to content delivery system 130. The query terms may be entered through client device 110 through one or more ways.

For example, a user of client device 110 may select one or more characters on (a) a physical keyboard of client device 110 or (b) a graphical keyboard that is presented on a touchscreen display of client device 110. Such selection may occur while a keyboard cursor is within a particular text field of a user interface that is presented on a screen of client device 110. After each character is selected, the character is transmitted over network 120 to content delivery system 130. A client application executing on client device 110 transmits the character(s) to content delivery system 130. Examples of such a client application include (1) a web application that executes within a web browser that executes on client device 110 and (2) a native application that is installed on client device 110 and is configured to communicate with content delivery system 130. The transmission of the input may include only the most recently selected character or may include all characters that have been entered thus far in the particular text field or thus far during a user session.

As another example, a user of client device 110 speaks one or more characters or words and a microphone of client device 110 detects the audible input and generates digital voice data therefrom. After which, a client application executing on client device 110 transmits the digital voice data to content delivery system 130.

Content delivery system 130 receives the input through query interface 132. The input may comprise text data or voice data. If the input comprises text data, then the text data comprises one or more characters, such as alphanumeric characters. If the input comprises voice data, then query interface 132 (or another element of content platform) translates the voice data into one or more characters.

Query auto-completion component 134 generates one or more auto-completed queries based on the input received through query interface 132 and causes the one or more auto-completed queries to be transmitted over network 120 to be presented on a screen of client device 110. Each auto-completed query may be associated with a document type, which reflects a predicted search intent. In response, a user may select one of the auto-completed queries that is presented on the screen of client device 110. An indication of the selection is transmitted from client device 110 to content delivery system 130. The indication may also include a document type that is associated with the selected auto-completed query.

Searcher 136 performs a search based on the selected auto-completed query by searching document database 138, which may comprise multiple databases, each corresponding to a different document type, or may comprise a single database that stores documents of multiple types. Searcher 136 may use the document type associated with the selected auto-completed query as a filter on the search, limiting searcher 136 to consider only documents of that document type.

Search result ranker 140 ranks the documents retrieved by searcher 136. Though depicted as separate from searcher 136, the functionality of search result ranker 140 may be incorporated into searcher 136. Search result ranker 140 may rank the documents based on a prediction associated with each document type. For example, if the prediction is that the user is likely interested in a first document type, then documents of the first document type are ranked higher than documents of other document types, all else being equal. Other factors may be used to rank the retrieved documents, such as a level of a match and where the match occurs. For example, if the incomplete query matches a first document more than a second document, then the first document is ranked higher, all else being equal. As another example, if the incomplete query matches a first document in a title or name portion of the first document and the incomplete query matches a second document in a lower priority portion (e.g., the body) of the second document, then the first document is ranked higher than the second document, all else being equal.

The selected auto-completed query, the associated document type, and the incomplete query that was used to generate the selected auto-completed query are stored (e.g., in a single record) in query history log 142. Query history log 142 stores records for multiple selected auto-completed queries. Each record may correspond to a different user and/or client device. Some records may correspond to the same user, indicating that that user selected multiple auto-completed queries, whether in a single user session with content delivery system 130 or in different user sessions.

In some implementations, content delivery system 130 provides one or more search results (“anticipatory search results”) of an auto-completed query for presentation on client device 110 in response to receiving an incomplete query. Thus, content delivery system 130 automatically performs a search based on an auto-completed query even though a user that provided (e.g., entered) the incomplete query did not select the auto-completed query. If the user selects an anticipatory search result or otherwise provides input that indicates interest in an anticipatory search result, then the document type associated with the anticipatory search result is stored in a record associated with the incomplete query. The record may also include the anticipatory search result.

### Rule-Based Model

Predicting a document type based on one or more characters may be performed in a number of ways. For example, hard-coded rules may be established that (1) identify certain attributes of the input and/or of the user that provided by the input, each input attribute and user attribute corresponding to a different score and (2) based on a combination of all the scores, determine a score for the input. For example, the last two searches performed by the user where the document type is known may result in three points for that (first) document type, the input matching a past search that resulted in a second document type 70% of the time may be result in six points for that document type. Thus, the rule-based model may predict that there is a 33% probability that the document type is the first type and that there is a 66% probability that the document type is the second type.

A rule-based model has numerous disadvantages including failing to capture nonlinear correlations and the fact that the hand-selection of values (e.g., weights or coefficients) for each feature is error-prone, time consuming, and non-probabilistic. Hand-selection also allows for bias from potentially mistaken business logic.

Additionally, the output of a rule-based model is typically an unbounded positive or negative value and, therefore, does not intuitively map to the probability of selecting a particular document type for which the model is optimizing (e.g., predicting).

### Machine-Learned Model

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with input and, optionally, users. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating or training a model. Example machine learning techniques include linear regression, logistic regression, neural networks, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

Initially, the number of features that are considered for training may be significant. After training a machine-learned model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future models and computing output scores.

### Model Trainer

Model trainer 144 trains a classification model 146 using one or more machine learning techniques and based on training data that is generated based on query history log 142. Model trainer 144 (or another component of content delivery system 130) analyzes query history log 142 and generates training samples/instances for the training data. Each training instance includes one or more characters and a label that indicates a document type. Each document type corresponds to a different label or classification. Thus, if there are six document types, then there are six labels or classifications.

In an embodiment, for each space character in a training instance, that space character is replaced with a special token (e.g., “[SPACE]”). Similarly, for each unknown character in a training instance, that unknown character is replaced with another special token (e.g., “[UNK]”). Examples of unknown characters are emoticons.

The document type of a training instance may be determined by analyzing query history log 142 and determining, for an incomplete query, which auto-complete query a user (that entered the incomplete query) selected or which anticipatory search result the user selected.

The document type indicated in a training instance is one of multiple possible document types, such as a person document, a company document, an academic institution document, a group document, an event document, and a job posting. Each document type may have its own formatting and unique set of attributes. For example, a person document may be a user profile in an online connection network (e.g., provided by LinkedIn) where attributes of a user profile include first name, last name, job title, industry, job function, employment status, academic degrees earned, academic institutions attended, work history, skills, endorsements, and recommendations. As another example, a company document may be a company profile whose attributes include company name, location, business address, industry, number of employees, number of offices, and number of job openings. Example attributes of a group document include a group name, a group mission statement, a group logo, a list of past events hosted by the group, a list of upcoming events affiliated with the group, and a list of members of the group. Example attributes of an event document include an event name, an event location, a cost of attending the event, a list of names of organizers of the event, contact details regarding how to register for the event, and current attendees of the event. One document of a particular type may have values for a first subset of the attributes of the particular type while another document of the particular type may have values for a second subset (that is different than the first subset) of the attributes of the particular type.

Based on input, classification model 146 generates or outputs a set of values, each reflecting a probability that the user that provided the input intended to search for a particular document type. Thus, if there are six possible classifications, then classification model 146 outputs six values, some of which may be at or near 0, indicating a low likelihood that the user intended to search for documents of the corresponding document type.

### Artificial Neural Network

An example of classification model 146 is an artificial neural network (ANN). An ANN is based on a collection of connected units or nodes, referred to as artificial neurons. Each connection allows for the transmission of a signal from one neuron to one or more neurons. A first neuron that receives a signal processes the signal and signals neurons that are connected to the first neuron. The signal received through a connection is a real number and the output of each neuron is computed by a non-linear function of the sum of its inputs. The connections are referred to as “edges.”

Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times. In addition to an input layer and an output layer, a neural network may have one or more inner or hidden layers.

An example of the final or output layer of a neural network is a softmax function. A softmax function is a generalization of the logistic function to multiple dimensions and is used in multinomial logistic regression. A softmax function is often used as the last activation function of a neural network to normalize the output of a network to a probability distribution over predicted output classes.

An input layer of an ANN takes, as input, one or more embeddings, each embedding corresponding to a character that a user inputs into a search interface presented on client device 110. An embedding is a vector of real (e.g., floating point) numbers, each number corresponding to a different latent dimension. The number of latent dimensions (e.g., 64) is configurable at the pre-training stage. Initially, before training begins, each character is assigned a random embedding, or an embedding where each number in the vector is randomly selected. Then during the training stage, for each training instance, model trainer 144 not only updates weights of one or more edges and/or one or more neurons in the ANN, but also the embeddings that correspond to the characters indicated in the training instance.

The training process for ANNs involves gradient descent and backpropagation. Gradient descent is an iterative optimization algorithm for finding the minimum of a function; in this case, a loss function. Backpropagation is a method used in ANNs to calculate the error contribution of each neuron after a batch of data is processed. In the context of learning, backpropagation is used by a gradient descent optimization algorithm to adjust the weight of neurons in an ANN by calculating the gradient of the loss function. Backpropagation is also referred to as the “backward propagation of errors” because backpropagation begins at the final (output) layer (that generates the probabilities) by calculating the error at the output and distributing that error back through the ANN layers. For models involving embeddings, there is an implicit input layer that is often not mentioned. The embeddings are actually a layer by themselves and backpropagation goes all the way back to the embedding layer. The input layer maps inputs to the embedding layer. Batch size depends on several factors, including the available memory on the computing device or GPU.

A character is a symbol that represents a letter or a number. In the English language, the number of possible alphabetic characters is 26. Other languages have more or fewer alphabetic characters. However, a user might input (e.g., type in, select, or otherwise enter) other types of characters, such as a numeric character (e.g., 0 through 9), an emoji, or an unknown character. In an embodiment, multiple characters map to (or are associated with) a particular embedding. For example, numeric characters map to a first embedding, while emojis and unknown characters map to a second embedding. Therefore, a single embedding may represent multiple characters. Thus, whenever a user inputs a numeric character, then a particular embedding is retrieved for that numeric character, regardless of the specific numeric character inputted.

### Examples of Artificial Neural Networks

An example of a neural network is a convolutional neural network (CNN), which is a class of deep neural networks. CNNs have applications in image and video recognition, recommender systems, image classification, medical image analysis, natural language processing, and financial time series.

CNNs are regularized versions of multilayer perceptrons. Multilayer perceptrons usually mean fully connected networks; that is, each neuron in one layer is connected to all neurons in the next layer. However, the “fully-connectedness” of these networks makes them prone to overfitting data. One way to combat overfitting is through regularization, which includes adding some form of magnitude measurement of weights to the loss function. CNNs take a different approach towards regularization. CNNs take advantage of the hierarchical pattern in data and assemble more complex patterns using smaller and simpler patterns.

CNNs use relatively little pre-processing compared to other classification algorithms. This means that a CNN learns the filters that in traditional algorithms were hand-engineered. This independence from prior knowledge and human effort in feature design is a significant benefit of CNNs.

Another example of a neural network is a recurrent neural network (RNN) where connections between neurons form a directed graph along a temporal sequence. This structure allows the neural network to exhibit temporal dynamic behavior. An RNN uses its internal state (memory) to process variable length sequences of inputs, which makes an RNN suitable for certain tasks, such as unsegmented, connected handwriting recognition and speech recognition.

### Query Auto-Completion Component

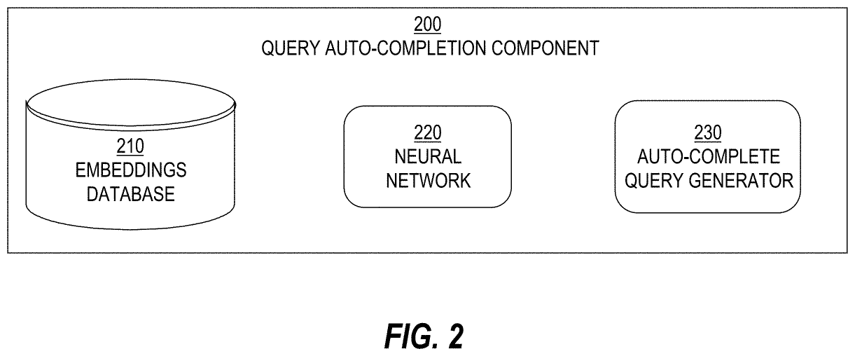

FIG. 2 is a block diagram that depicts an example query auto-completion component 200 that corresponds to query auto-completion component 134 of FIG. 1. Query auto-completion component 200 includes an embeddings database 210, a neural network 220, and an auto-complete query generator 230. Embeddings database 210 stores embeddings that were learned (or generated by model trainer 144) while training neural network 220 based on training data that was generated from query history log 142.

Query auto-completion component 200 receives an incomplete query, for example, from client device 110. The incomplete query may comprise one or more characters. In response to receiving the incomplete query, query auto-completion component 200 retrieves an embedding from embeddings database 210 for each character in the incomplete query. Thus, if the incomplete query includes three characters, then three embeddings are retrieved from embeddings database 210.

Each entry or record in embeddings database 210 may store an association (directly or indirectly) between a character and an embedding. For example, query auto-completion component 200 retrieves a character identifier for a character in an incomplete query and then uses the character identifier to lookup the corresponding embedding in embeddings database 210.

Query auto-completion component 200 inputs the retrieved embeddings into neural network 220, which has been trained using one or more machine learning techniques. Inputting an embedding into neural network 220 involves, for a particular neuron in the input layer, for each data value or number in the embedding, applying a learned weight to that data value (e.g., multiplying the data value by a weight), where the learned weight corresponds to a position in the embedding occupied by the data value. If an embedding has one hundred data values, then there are one hundred learned weights. Then, the results of applying each data value to a corresponding weight are combined (by the particular neuron) to produce an output. The operation may be v1*w1+v2*w2+v3*w3 . . . +v100*w100, where v is the value, and w is the weight. If there are multiple input neurons, then this process repeats for each of those input neurons; however, the weights that have been learned for each embedding position is likely to be different than the weights learned for other input neurons.

Neural network 220 produces or outputs multiple values, each reflecting a probability that the user intends to search for one or more documents of a particular type. In other words, the output of neural network reflects multiple predictions of the search intent of the user. For example, one output value indicates a first probability that the user is searching for user profiles while another output value indicates a second probability that the user is searching for company profiles.

Auto-complete query generator 230 generates one or more auto-completed queries based on the output from neural network 220. For example, if the output reflects a prediction of 50% that the intended document type or search intent is user profiles, then 50% of auto-completed queries may correspond to user profiles. Similarly, if the output reflects a prediction of 20% that the intended document type or search intent is group profiles, then 20% of auto-completed queries may correspond to group profiles.

### Example Presentation

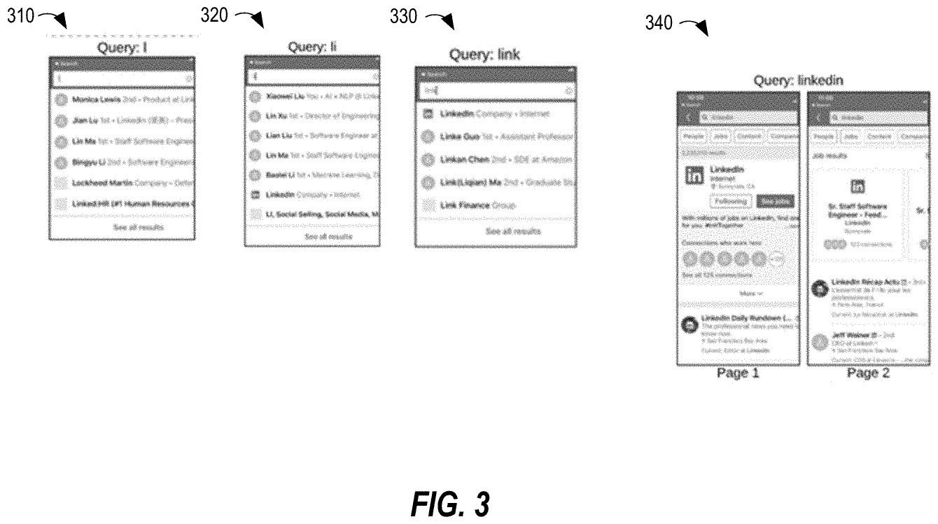

FIG. 3 comprises screenshots of example presentations of a user interface as a user inputs an incomplete query, in an embodiment. The user interface depicted in each of screenshots 310-330 is presented on a screen of computing device, such as client device 110. The user interface is generated by a client application that is executing on the computing device. The client application may be (a) a web application that originates from content delivery system 130 (and that is executing within a web browser of the computing device) or (b) a native application that is installed on the computing device.

Each of screenshots 310-330 includes a text field into which a user enters characters. The characters may be entered with a physical keyboard or a graphical keyboard, neither of which is depicted in any of the screenshots. The client application sends the entered characters over a computer network to a server application executing on content delivery system 130, which server application generates results. The results may be in the form of one or more auto-completed queries, one or more anticipatory search results that are determined based on one or more of the auto-completed queries, or a combination of both. The server application transmits the results to the client application, which updates the user interface with the results. The time period from character input through the client application to display of the results may be less than one second, which is effectively real-time or near real-time.

According to screenshot 310, the user has entered one character in the text field: “1”. In response, query auto-completion component 200 identifies at least six auto-completed queries, four of which are associated with a user profile document type, one of which is associated with a company profile document type, and one of which is associated with a job posting document type. This may due to the fact that output from neural network 220, based on input “1”, indicated: (1) an approximately 66% probability that the user has a user profile search intent; (2) an approximately 17% probability that the user has a company profile search intent; and (3) an approximately 17% probability that the user has a job posting search intent.

Each auto-completed query in the depicted examples is also accompanied by additional information associated with the auto-completed query. The type of information that accompanies an auto-completed query may vary depending on the document type associated with the auto-completed query. For example, if the document type is user profile, then the additional information may include a number of degrees between the user and the person associated with the auto-completed query, a job title, and/or an employer name. As another example, if the document type is company profile, then the additional information may include a document type and/or an industry.

According to screenshot 320, the user has entered two characters into the text field: “li”. In response, query auto-completion component 200 identifies at least seven auto-completed queries, five of which are associated with a user profile document type, one of which is associated with a company profile document type, and one of which is associated with a job posting document type.

According to screenshot 330, the user has entered four characters into the text field: “link”. In response, query auto-completion component 200 identifies at least five auto-completed queries, one of which are associated with a company profile document type, three of which are associated with a user profile document type, and one of which is associated with a group profile document type. In this example, even though only one company profile is presented, query auto-completion component 200 (or search result ranker 140) makes a prediction (using classification model 146 or neural network 220), based on the input, that the company profile document type is the highest probability of being selected or searched for. It may be the case that searcher 136 did not find any other relevant company profile and, therefore, only one auto-completed query associated with that document type was retrieved.

Screenshot 340 depicts a user interface in response to (a) the user selecting the top ranked auto-completed query (“LinkedIn”) indicated in screenshot 330 or (b) the user entering each of those characters. Screenshot 340 comprises two pages of information and options for the user to select, such as an option to follow the company, an option to view job postings from the company, an indication of a number of the user's connections who work at the company, and information about high profile principals or executives of the company.

### Example Process

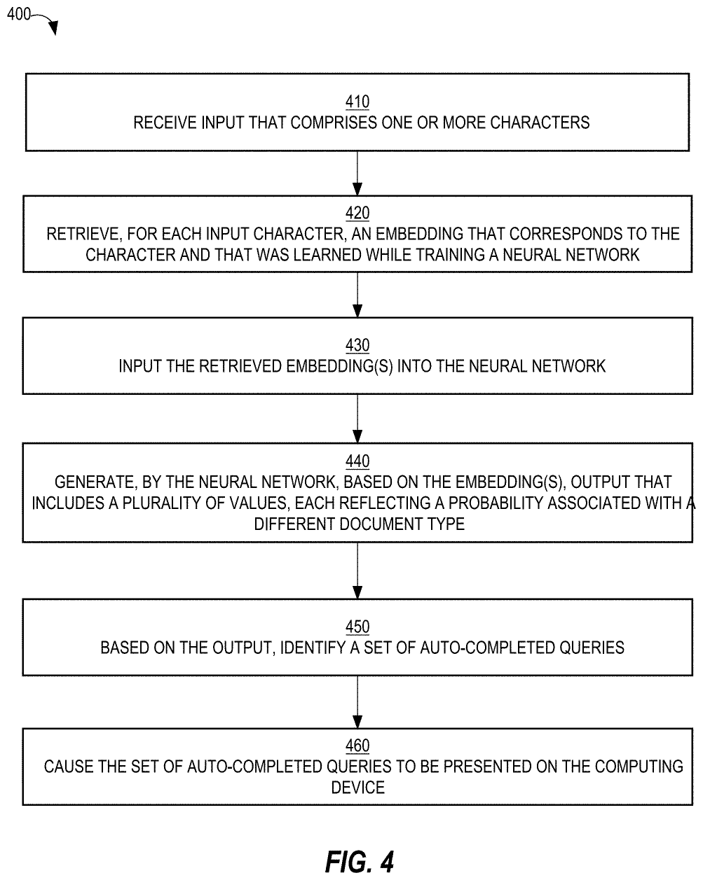

FIG. 4 is a flow diagram that depicts an example process 400 for processing incomplete queries, in an embodiment. Process 400 may be performed by query auto-completion component 200 and one or more elements of system 100.

At block 410, input that comprises one or more characters is received (e.g., over a computer network) from a computing device, such as client device 110. The input may be text input. Block 410 may be performed by query interface 132.

At block 420, for each character, an embedding that corresponds to the character is retrieved. The character embedding has been machine-learned while training a neural network, such as neural network 220.

At block 430, the retrieved embedding(s) are input into the neural network.

At block 440, the neural network generates an output that includes a plurality of values, which includes at least two values. One of the values reflects (or is) a probability that the input is associated with a first document type (or reflects a user intent to search for a document of a first document type), while another value reflects (or is) a probability that the input is associated with a second document type (or reflects a user intent to search for a document of a second document type).

At block 450, based on the outputted probabilities, a set of auto-completed queries is identified. For example, if a particular document type is associated with the highest probability, then a majority of the auto-completed queries in the set will be associated with that particular document type. As another example, if a document type is associated with a probability that is below a particular threshold, then an auto-completed query of that document type is not included in the set of auto-completed queries.

At block 460, the set of auto-completed queries is caused to be presented on the computing device. Block 460 may involve transmitting the set of auto-completed queries over a computer network to the computing device that transmitted the input.

### Long Short-Term Memory Network

An example of an RNN is a long short-term memory (LSTM) network. LSTM networks are well-suited to classifying, processing, and making predictions based on time series data because there may be lags of unknown duration between important events in a time series. LSTM networks were developed to deal with the vanishing gradient problem that can be encountered when training traditional RNNs. Relative insensitivity to gap length is one advantage of LSTM over RNNs, hidden Markov models, and other sequence learning methods in numerous applications.

An LSTM network includes an LSTM portion and, optionally, a non-LSTM portion that takes, as input, output from the LSTM portion and generates an output (e.g., a classification) of its own. The LSTM portion includes multiple LSTM units. Each LSTM unit in an LSTM network may be identical in structure to every other LSTM unit in the LSTM network.

A LSTM unit may be composed of a cell, an input gate, an output gate, and a forget gate. Some variations of the LSTM unit do not have one or more of these gates or may have other gates. The cell “remembers” values over arbitrary time intervals and the three gates regulate the flow of information into and out of the cell. An advantage of an LSTM cell compared to a common recurrent unit is its cell memory unit. The cell vector has the ability to encapsulate the notion of “forgetting” part of its previously stored memory, as well as to add part of the new information. To illustrate this, one must inspect the equations of the cell and the way the cell processes sequences of data.

Intuitively, the cell is responsible for keeping track of the dependencies between the elements in an input sequence. The input gate controls the extent to which a new value flows into the cell, the forget gate controls the extent to which a value remains in the cell, and the output gate controls the extent to which the value in the cell is used to compute the output activation of the LSTM unit. The activation function of the LSTM gates may be a logistic sigmoid function. The activation function of each LSTM gate may be different.

There are connections into and out of the LSTM gates, a few of which are recurrent. The weights of these connections, which are learned during training, determine how the gates operate. If the number of gates in an LSTM unit is four and there are 64 elements or data values in an embedding, then an LSTM unit may have 4*(hidden_size*(input+output)+bias)=4*(64*(64+64)+64)=33,024 weights that are learned during training.

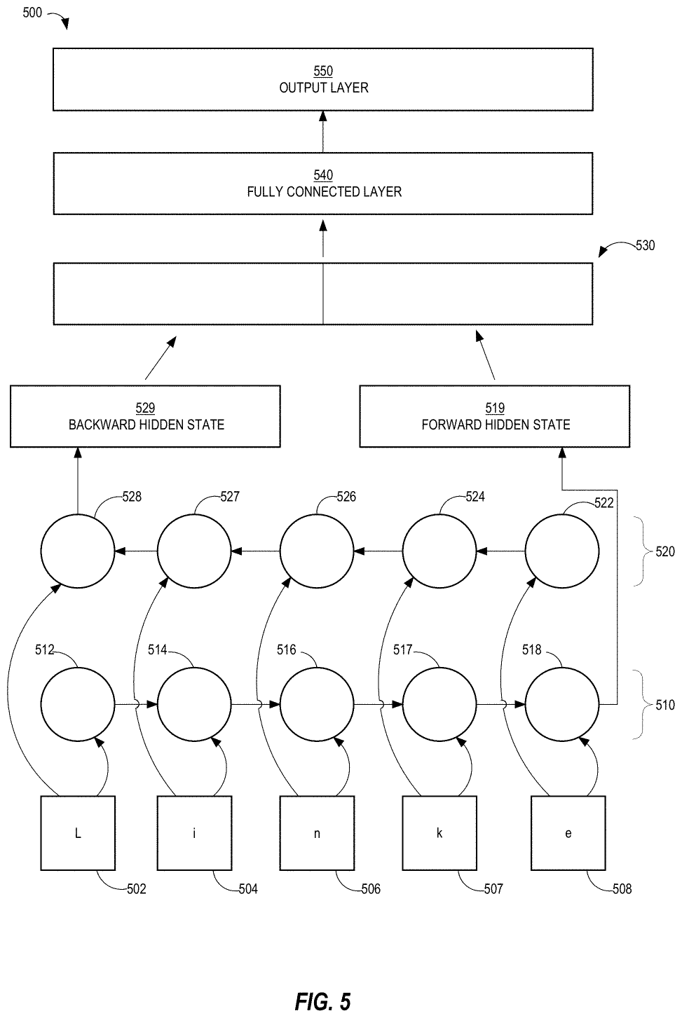

FIG. 5 is a block diagram that depicts an example LSTM network 500 for predicting document type based on an incomplete query, in an embodiment. LSTM network 500 includes a forward layer 510, a backward layer 520, a forward hidden state 519, a backward hidden state 529, an intermediate representation 530, a fully connected layer 540, and an output layer 550. Because LSTM network 500 includes a forward layer and a backward layer, LSTM network 500 is considered a bi-directional LSTM network. In an embodiment where LSTM network 500 is a uni-directional LSTM network, LSTM network 500 would exclude backward layer 520 and backward hidden state 529.

The LSTM portion of LSTM network 500 includes layers 510 and 520. Each layer comprises a set of LSTM units. Forward layer 510 includes LSTM units 512-518 and backward layer 520 includes LSTM units 522-528. The output of forward layer 510 is forward hidden state 519, while the output of backward layer 520 is backward hidden state 529.

The number of LSTM units in the LSTM portion of LSTM network 500 (i.e., forward layer 510 and in backward layer 520 in this example) may be established or fixed by analyzing the length of past incomplete queries. For example, the vast majority of incomplete queries (as indicated in query history log 142) may be less than six characters before a user selects one of the auto-completed queries. Therefore, the number of LSTM units in each of layers 510 and 520 may be five. Then, during invocation of LSTM network 500 in response to receiving an incomplete query, if the incomplete query is less than five characters, then one or more instances of an embedding for “padding” is used. For example, if an incomplete query is two characters and the number of LSTM units in each of layers 510 and 520 is five, then three instances of a padding embedding are generated or retrieved and inputted into layers 510-520 along with embeddings for the two characters. If there are any padding embeddings, then the padding embeddings may be placed subsequent to the retrieved character embeddings when input to forward layer 510 and backward layer 520.

In the example depicted in FIG. 5, there are five character embeddings: 502-508, each corresponding to a different input character. Each character embedding is input into two different LSTM units, each from a different layer. Thus, character embedding 502 is input to LSTM unit 512 and LSTM unit 528; character embedding 504 is input to LSTM unit 514 and LSTM unit 527; and so forth.

The first LSTM unit in each of layers 510 and 520 (i.e., LSTM unit 512 and LSTM unit 522) has one input, while non-first LSTM units in each layer have two inputs: one input for a character embedding and one input that is output from a previous LSTM unit in the same layer. Each of layers 510 and 520 have a last or “final” LSTM unit. Output from the last LSTM unit are query features that represent a last hidden state: for forward layer 510, that is last hidden state 519; for backward layer 520, that is last hidden state 529.

The respective last hidden states are combined (e.g., concatenated) to generate intermediate representation 530. If concatenated, then intermediate representation 530 is twice the size of each last hidden state (presuming that the last hidden states are equal in size). Intermediate representation 530 is (optionally) input to a fully connected layer 540, which itself may comprise multiple layers. For example, the intermediate representation may be 128 data values (e.g., floating point numbers) and each data value is input into 128 different neurons in fully connected layer 540, each of the 128×128 different inputs associated with a potentially different weight.

Output of fully connected layer 540 (if one exists) is input to output layer 550 (which may be a softmax layer); otherwise, intermediate representation 530 is input to output layer 550. Output layer 550 outputs a plurality of values, each corresponding to a different document type and associated with a different document type. Each value may be a probability that the user is searching for a document of the corresponding document type.

If a user enters a subsequent character, then an embedding is retrieved for that character and is input, along with embeddings of previously entered characters of the incomplete query, to each of layers 510 and 520. For example, content delivery system 130 receives an incomplete query “li” and, in response, retrieves an embedding for “1” and an embedding for “i” and inputs both embeddings and three padding embeddings into each of layers 510 and 520 of LSTM network 500. After LSTM network 500 outputs a prediction based on the embeddings (or while LSTM network 500 is processing the embeddings), content delivery system 130 receives an “n” as a subsequent character to the input “li”. In response, content delivery system 130 retrieves an embedding for “n” and inputs the three character embeddings and two padding embeddings into each of layers 510 and 520. Each time LSTM network 500 is invoked, the first character from the user input is input to the first LSTM unit in each of layers 510 and 520, the second character from the user input is input to the second LSTM unit in each of layers 510 and 520, and so forth.

### Multi-Lingual Model

The examples herein of input to content platform are in English. However, embodiments are not limited to the English language, but are applicable to other languages as well. In an embodiment, a single model is trained based on input from multiple languages, such as English, Spanish, French, Portuguese, and Italian. Non-Latin based languages (e.g., Slavic and Indian) may use the same model, but the character embedding values would be different.

Advantages of this approach where a single machine-learned model is used to predict document type include: (1) not having to construct, train, and maintain multiple language-specific models, which would be error-prone, time intensive, and computer resource intensive; (2) not having to store multiple language-specific models at serving time and select one of those models on-the-fly; (3) and one language effectively “learns” from one or more other languages. Additionally, the number of training instances for some languages is relatively low. Therefore, some language-specific models perform poorly due to the lack of a sufficient number and variety of training data. Experiments have shown that a single model approach yields more accurate predictions than leveraging multiple language-specific models.

The identity of a language may be determined in one or more ways. For example, a user might specify a language preference in a user profile (of the user) that is accessible to content delivery system 130. Thereafter, when the user enters a search query, content delivery system 130 retrieves the user's profile and identifies the language preference. As another example, content delivery system 130 analyzes the content of an incomplete query to determine one or more languages in which the incomplete query is composed.

As another example, a search request from client device 110 includes a (“interface locale”) parameter that identifies a language. This parameter may be set based on where client device 110 is geographically located, which may be determined based on the source IP address and/or attributes or identities of nodes that the search request traverses in network 120. Using such a parameter has a number of advantages, such as: (1) being a strong indicator of the spoken language; (2) queries from the same interface locale bare information other than language (such as entities specific to an interface locale; for example, in China, the “baidu” company name appears much more frequently than in the United States); (3) identifying languages with language detection models rely on model performance, which could introduce another layer of complexity and may introduce errors; (4) being easy to develop and maintain for offline data collection and online serving/testing. Additionally, attempting to accurately determine, using an automated system in real-time, a language from a relatively short sequence of characters is very difficult.

### Injecting Language Features into a Machine-Learned Model

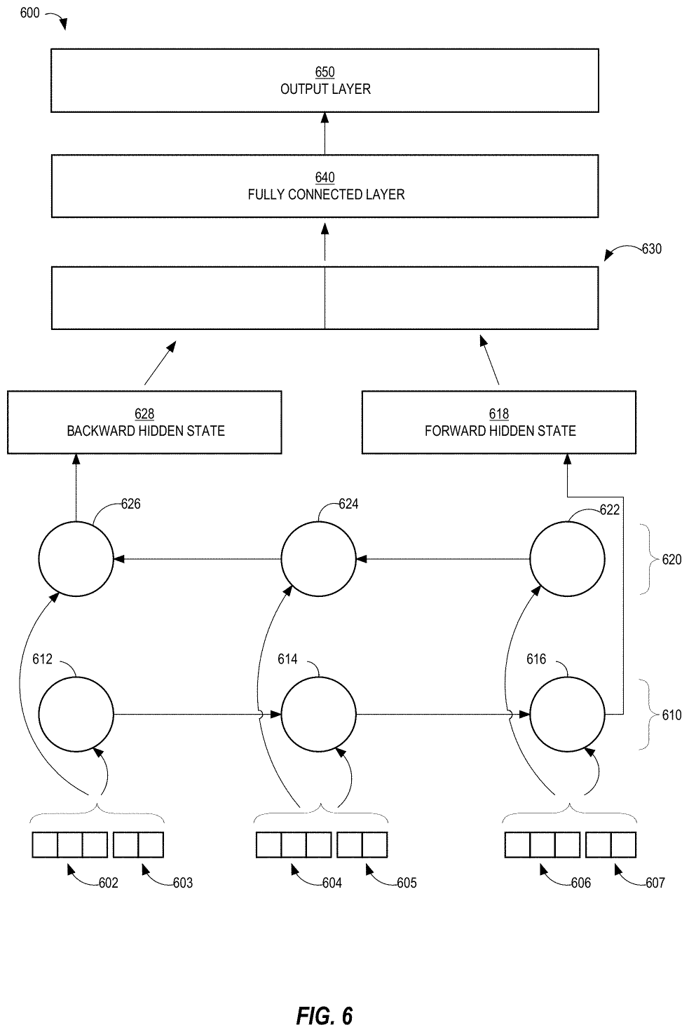

There are at least three approaches for injecting a language feature into classification model 146. FIGS. 6-8 are block diagrams that depict simplified versions of LSTM network 500, but where a language feature is modeled, in an embodiment. Each of neural networks 600, 700, and 800 is a simplified version of LSTM network 400 because each of neural networks 600, 700, and 800 includes fewer LSTM units in the forward and backward layers. However, embodiments are not limited to this number of LSTM units.

FIG. 6 depicts an example neural network 600 where an interface locale parameter is embedded into query features. In this first approach, each character embedding (i.e., character embeddings 602, 604, and 606) that is retrieved for each character that a user inputs into client device 110 is concatenated with a language (or interface locale) embedding that has been machine-learned (initialized randomly) while training neural network 600. Embeddings 603, 605, and 607 are different instances of the same language embedding. The concatenated embeddings are fed through the bi-directional portion of network 600 to extract interface locale “embedded” query features in the form of hidden states 618 and 628. To the extent that there is a padding character, space character, or an unknown character, an embedding of such a character may also be concatenated with the language embedding.

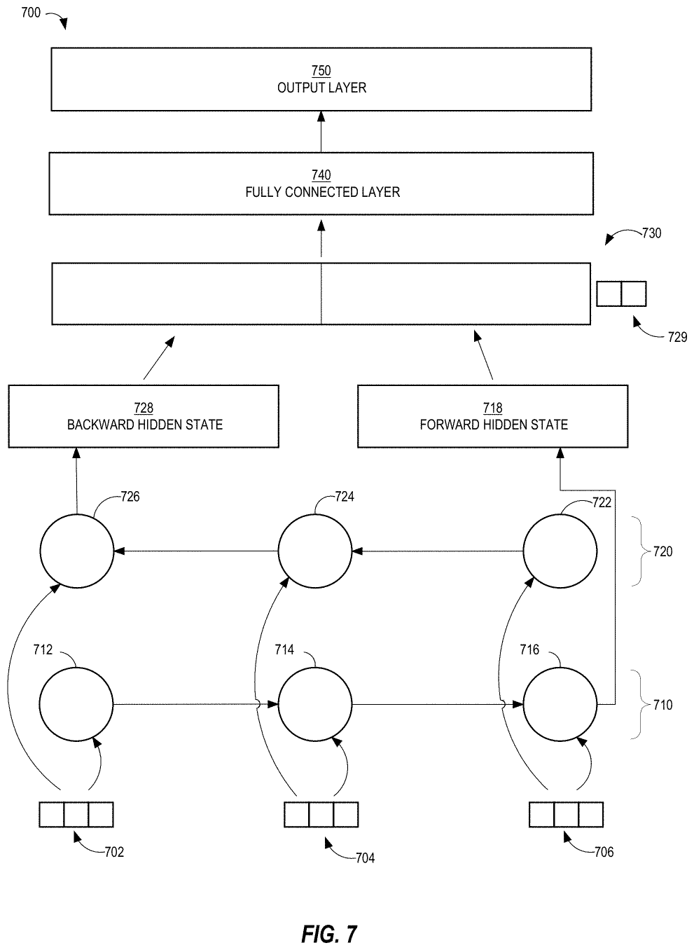

FIG. 7 depicts an example neural network 700 where an embedding 729 of a language indicated by an interface locale parameter is concatenated with hidden states 718 and 728 produced by the bi-directional LSTM portion (i.e., forward layer 710 and backward layer 720) of neural network 700. This concatenation produces an intermediate representation 730. (Again, the language (or interface local) embedding is initialized randomly prior to the initiation of training neural network 700.) Thus, this second approach (1) uses the bi-directional portion of neural network 700 to extract query features from the character embeddings (as before) and then (2) concatenates the language (or interface locale) embedding 729 to the last output state of the bi-directional portion of neural network 700.

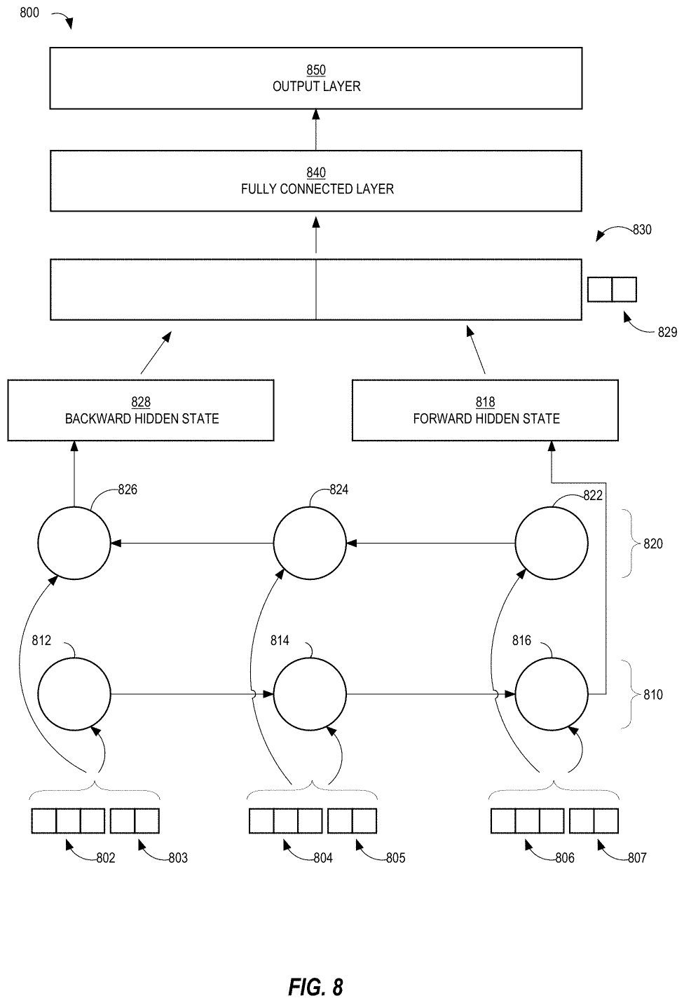

FIG. 8 depicts an example neural network 800 where the approaches of FIGS. 6 and 7 are combined. This approach enables embedding the language features into the query features by appending the language embedding to each of the character embeddings, while also attaching the language embedding to the query features extracted from the bi-directional portion of neural network 800.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

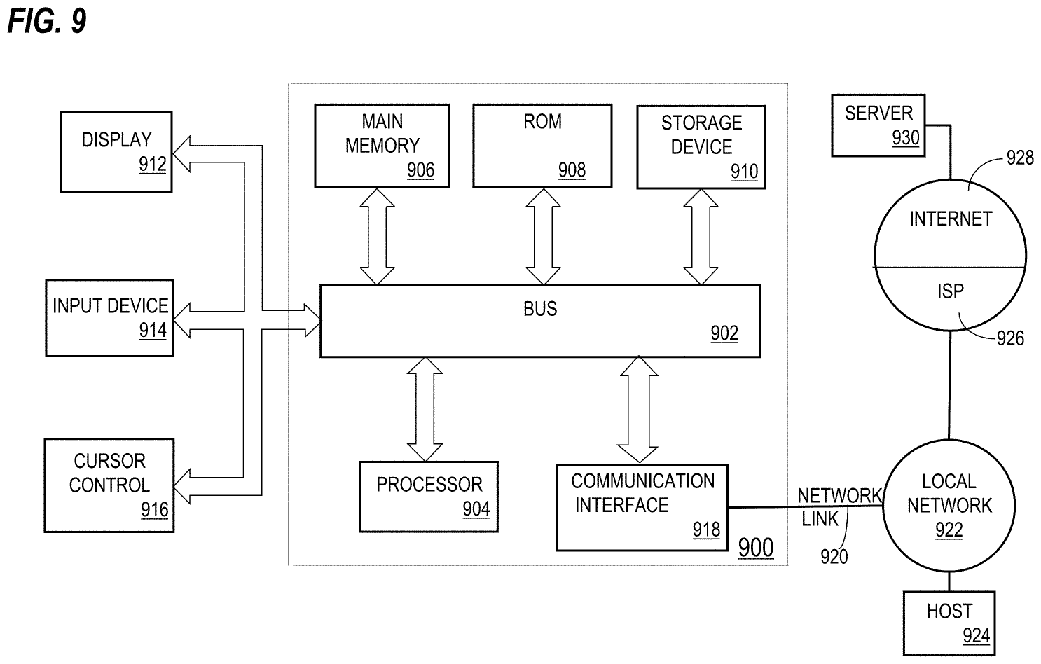

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
in response to receiving, through an interface of a computing device, input that comprises one or more characters:
for each character in the one or more characters, retrieving an embedding that corresponds to said each character and that was machine-learned while training a neural network that outputs a plurality of classifications, each corresponding to a different document type;
inputting one or more embeddings, each corresponding to one of the one or more characters, into the neural network;
based on the inputting, generating, by the neural network, an output that comprises a plurality of values that includes (1) a first value that reflects a first probability that the input is associated with a first document type and (2) a second value that reflects a second probability that the input is associated with a second document type that is different than the first document type;
based on the first and second probabilities, identifying a set of query completions;
causing the set of query completions to be presented on the computing device;
wherein the method is performed by one or more computing devices.

2. The method of claim 1, wherein:
the neural network is a long short-term memory (LSTM) network that comprises a LSTM portion and a non-LSTM portion;
the LSTM portion comprises a plurality of LSTM units;
the one or more characters is a plurality of characters;
the one or more embeddings is a plurality of embeddings;
inputting the plurality of embeddings into the neural network comprises:
for each embedding of the plurality of embeddings, inputting said each embedding into a different LSTM unit of the plurality of LSTM units;
generating the output comprises using the neural network to generate an LSTM output that is output of the LSTM portion;
the output is based on the LSTM output.

3. The method of claim 2, wherein:
the plurality of LSTM units is a first plurality of LSTM units that is part of a forward layer of the LSTM portion;
the LSTM portion comprises a second plurality of LSTM units that is part of a backward layer of the LSTM portion;
generating the LSTM output comprises:
using the neural network to generate a forward output that is output of the forward layer based on the plurality of embeddings;
using the neural network to generate a backward output that is output of the backward layer based on the plurality of embeddings;
combining the forward output and the backward output to generate a combined output;
the output is based on the combined output.

4. The method of claim 2, wherein generating the output comprises inputting the LSTM output to a final layer that produces the output.

5. The method of claim 1, wherein the input is first input, the method further comprising:
receiving, through the interface of the computing device, second input that comprises a subsequent character after the one or more characters, wherein the subsequent character and the one or more characters are a plurality of characters;
retrieving, based on the subsequent character, a second embedding that has been machine-learned while training the neural network;
inputting the one or more embeddings and the second embedding into the neural network;
based on inputting the one or more embeddings and the second embedding, generating, by the neural network, a second output that comprises a second plurality of values that includes (1) a third value that reflects a third probability that the first and second input reflect the first document type and (2) a fourth value that reflects a fourth probability that the first and second input reflect the second document type;
based on the third and fourth probabilities, identifying a second set of query completions;
causing the second set of query completions to be presented on the computing device.

6. The method of claim 1, wherein the neural network comprises an input layer that comprises a first number of units, wherein the one or more characters comprise a second number of characters that is less than the first number of units, the method further comprising:
identifying a padding embedding;
generating a number of padding embeddings that are equal to a difference between the first number of units and the second number of characters;
wherein inputting the one or more embeddings into the neural network also comprises inputting the padding embeddings into the neural network.

7. The method of claim 1, wherein the one or more characters are a plurality of characters, the method further comprising:
determining that a particular character in the plurality of characters is an unknown character;
retrieving, for the unknown character, a particular embedding that has been machine learned while training the neural network.

8. The method of claim 1, further comprising:
identifying a log of user sessions, each containing interaction data about one or more incomplete queries provided by a user and a selection, by the user, of an anticipatory search result that corresponds to a document type;
for each user session indicating the log:
generating a training instance that includes an incomplete query and a document type, and
adding the training instance to training data;
using one or more machine learning techniques to train the neural network based on the training data.

9. The method of claim 1, wherein the plurality of classifications include a person document type, a company document type, a group document type, an academic institution document type, and an event document type.

10. The method of claim 1, wherein:
the first probability is greater than the second probability;
the set of query completions include a first subset of query completions that correspond to the first document type;
the set of query completions include a second subset of query completions that correspond to the second document type;
the number of query completions in the first subset is greater than the number of query completions in the second subset based, at least in part, on the first probability being greater than the second probability.

11. The method of claim 1, wherein:
training the neural network results in machine learning a language embedding for a language of the input;
inputting the one or more embeddings also comprises inputting the language embedding into the neural network;
the output is based on the language embedding.

12. The method of claim 11, wherein receiving the input also comprises receiving an interface locale value in a search request that includes the input, the method further comprising, prior to inputting the language embedding into the neural network:
based on the interface locale value, retrieving the language embedding from storage that comprises a plurality of language embeddings, each corresponding to a different language.

13. The method of claim 11, wherein inputting the language embedding into the neural network comprises:
for each embedding of the one or more embeddings:
combining the language embedding with said each embedding to generate a combined embedding;
inputting the combined embedding into the neural network.

14. The method of claim 11, wherein the neural network is an long short-term memory (LSTM) network that comprises an LSTM portion and a non-LSTM portion, wherein inputting the language embedding into the neural network comprises:
combining the language embedding with an output of the LSTM portion to generate a combined embedding;
inputting the combined embedding into the non-LSTM portion of the LSTM network.

15. A method comprising:
in response to receiving, through an interface of a computing device, input that comprises one or more characters:
for each character in the one or more characters, retrieving an embedding that corresponds to said each character and that was machine-learned while training a long shorter-term memory (LSTM) neural network that comprises a non-LSTM portion and an LSTM portion that comprises a plurality of LSTM units;
for each embedding that corresponds to one of the one or more characters, inputting said each embedding into a different LSTM unit of the plurality of LSTM units;
using the LSTM neural network to generate an LSTM output that is output of the LSTM portion based on the one or more embeddings;
based on the LSTM output, using the non-LSTM portion to generate a final output that comprises a plurality of values that includes (1) a first value that reflects a first probability associated with a first document type and (2) a second value that reflects a second probability associated with a second document type that is different than the first document type;
based on the first and second probabilities, identifying a set of search results;
causing the set of search results to be presented on the computing device.
wherein the method is performed by one or more computing devices.

16. One or more storage media storing instructions which, when executed by one or more processors, cause:
in response to receiving, through an interface of a computing device, input that comprises one or more characters:
for each character in the one or more characters, retrieving an embedding that corresponds to said each character and that was machine-learned while training a neural network that outputs a plurality of classifications, each corresponding to a different document type;
inputting one or more embeddings, each corresponding to one of the one or more characters, into the neural network;
based on the inputting, generating, by the neural network, an output that comprises a plurality of values that includes (1) a first value that reflects a first probability that the input is associated with a first document type and (2) a second value that reflects a second probability that the input is associated with a second document type that is different than the first document type;
based on the first and second probabilities, identifying a set of query completions;
causing the set of query completions to be presented on the computing device.

17. The one or more storage media of claim 16, wherein:
the neural network is a long short-term memory (LSTM) network that comprises a LSTM portion and a non-LSTM portion;
the LSTM portion comprises a plurality of LSTM units;
the one or more characters is a plurality of characters;
the one or more embeddings is a plurality of embeddings;
inputting the plurality of embeddings into the neural network comprises:
for each embedding of the plurality of embeddings, inputting said each embedding into a different LSTM unit of the plurality of LSTM units;
generating the output comprises using the neural network to generate an LSTM output that is output of the LSTM portion;
the output is based on the LSTM output.

18. The one or more storage media of claim 17, wherein:
the plurality of LSTM units is a first plurality of LSTM units that is part of a forward layer of the LSTM portion;
the LSTM portion comprises a second plurality of LSTM units that is part of a backward layer of the LSTM portion;
generating the LSTM output comprises:
using the neural network to generate a forward output that is output of the forward layer based on the plurality of embeddings;
using the neural network to generate a backward output that is output of the backward layer based on the plurality of embeddings;
combining the forward output and the backward output to generate a combined output;
the output is based on the combined output.

19. The one or more storage media of claim 17, wherein generating the output comprises inputting the LSTM output to a final layer that produces the output.

20. The one or more storage media of claim 16, wherein the input is first input, wherein the instructions, when executed by the one or more processors, further cause:
receiving, through the interface of the computing device, second input that comprises a subsequent character after the one or more characters, wherein the subsequent character and the one or more characters are a plurality of characters;
retrieving, based on the subsequent character, a second embedding that has been machine-learned while training the neural network;
inputting the one or more embeddings and the second embedding into the neural network;
based on inputting the one or more embeddings and the second embedding, generating, by the neural network, a second output that comprises a second plurality of values that includes (1) a third value that reflects a third probability that the first and second input reflect the first document type and (2) a fourth value that reflects a fourth probability that the first and second input reflect the second document type;
based on the third and fourth probabilities, identifying a second set of query completions;
causing the second set of query completions to be presented on the computing device.
